(19) United States
(12) Patent Application Publication
(10) Pub. No.: US 2021/0035098 A1
(43) Pub. Date: Feb. 4, 2021

(54) METHODS AND SYSTEMS FOR MICROPAYMENT SUPPORT TO BLOCKCHAIN INCENTIVIZED, DECENTRALIZED DATA STREAMING AND DELIVERY

(71) Applicant: Theta Labs, Inc., San Jose, CA (US)

(72) Inventors: Jieyi Long, Santa Clara, CA (US); Mitchell C. Liu, Los Altos, CA (US)

(21) Appl. No.: 16/726,148

(22) Filed: Dec. 23, 2019

Related U.S. Application Data
(60) Provisional application No. 62/880,682, filed on Jul. 31, 2019.
(60) Provisional application No. 62/914,176, filed on Oct. 11, 2019.

(51) Int. Cl. G06Q 20/38; H04L 9/06

(52) U.S. Cl. CPC G06Q 20/38215; H04L 9/0637; H04L 2209/56; H04L 2209/38; H04L 9/0643

(57) ABSTRACT

Methods and systems for micropayment support to blockchain-incentivized, decentralized data streaming and delivery are disclosed. To receive a blockchain-based payment for streaming a data resource to multiple users, a caching node first joins a payment-authorized peer group and is notified upon the creation of a micropayment pool. After delivering a portion of the data resource to each user, a service receipt signed by the recipient user is obtained, and submitted to a payment server together with a payment authentication certificate. An updated off-chain transaction is obtained from the payment server, for later submission to the blockchain to claim a total payment from the micropayment pool.

### REFERENCE TO RELATED APPLICATIONS

This application is a non-provisional of and claims the benefit of priority to provisional application U.S. Ser. No. 62/880,682, filed on 31 Jul. 2019, entitled “Methods and Systems for Micropayment Support to Blockchain-Incentivized, Decentralized Video Streaming and Delivery,” and is a non-provisional of and claims the benefit of priority to provisional application U.S. Ser. No. 62/914,176, filed on 11 Oct. 2019, entitled “Methods and Systems for Decentralized Data Streaming and Delivery Network,” the entire disclosures of which are incorporated by reference in their entireties herein.

### NOTICE OF COPYRIGHTS AND TRADEDRESS

A portion of the disclosure of this patent document contains material which is subject to copyright protection. This patent document may show and/or describe matter which is or may become tradedress of the owner. The copyright and tradedress owner has no objection to the facsimile reproduction by anyone of the patent disclosure as it appears in the U.S. Patent and Trademark Office files or records, but otherwise reserves all copyright and tradedress rights whatsoever.

### FIELD OF THE INVENTION

Embodiments of the present invention are in the field of decentralized data delivery, and pertain particularly to methods and systems for micropayment support to blockchain-incentivized, decentralized data streaming and delivery through a distributed hybrid network.

### BACKGROUND OF THE INVENTION

The statements in this section may serve as a background to help understand the invention and its application and uses, but may not constitute prior art.

Internet video accounts for over three-quarters of all internet traffic today, and will increase further to 82% by 2022, according to Cisco's February 2019 Visual Networking Index (Cisco VNI™) Global IP Traffic Forecast for 2017-2022. The same report predicts that from 2017 to 2022, global Internet video traffic will grow four-fold, live Internet video will grow 15-fold, Virtual Reality and Augmented Reality traffic will grow 12-fold, and Internet gaming traffic will grow 9-fold. In the U.S., millennials between the ages of 18 and 34 are driving the growth of video streaming through the use of services like YOUTUBE, NETFLIX, HULU, and HBO. Streaming video among this group has jumped 256% from an average of 1.6 hours per week to 5.7 hours per week according to a SSRS Media and Technology survey, and mobile devices are leading the charge in video consumption.

Content Delivery Networks (CDNs), which are systems of distributed servers that minimize delay in delivering data to users by reducing the geographical distance between servers and users, are predicted by Cisco to carry 72% of Internet traffic by 2022, and they play an important role in distributing web content and streaming video data, by providing a backbone infrastructure to deliver data streams to end users. A major limitation of today's CDN networks is the so-called “last-mile” delivery problem, where a “last-mile” link between a limited number of Point-of-Presence (POPs) data centers and end users presents a bottleneck in the data streaming and delivery pipeline and often leads to less optimal user experience, including link failures, noticeable delays, choppy streams, poor picture quality, and frequent rebuffering. Another major concern is the CDN bandwidth cost, which can easily reach tens of millions of dollars per year for popular sites. These issues become more prominent with the coming era of high resolution digital media, for example 4K, 8K, and 360° VR streaming, and upcoming technologies such as light field streaming. For example, bandwidth requirements of today's mainstream 720p/HD streams jump by orders of magnitude for the newer systems.

To overcome such bandwidth limitations, decentralized peer-to-peer data streaming and delivery platforms have been developed based on self-organizing and self-configuring mesh networks. End users may share redundant or unused computing, bandwidth, and storage resources. Motivating and incentivizing users to actively share available resources require a secure and minimally delayed award system or payment method that is compatible with the decentralized natured of the peer-to-peer network. Also important is the ability to economically handle frequent, minuscule payments for small, individual data chunks transmitted to or received from one or more peers.

Therefore, in view of the aforementioned difficulties, there is an unsolved need to design a payment system for decentralized data streaming and delivery, including decentralized video streaming, with support for ultra-high transaction throughput. In addition, it would be necessary to detect, prevent, and penalize fraudulent activities such as double spending.

It is against this background that various embodiments of the present invention were developed.

### BRIEF SUMMARY OF THE INVENTION

Methods and systems are provided for off-chain blockchain transaction processing for data propagation and micropayments through a distributed mesh network.

More specifically, in one aspect, one embodiment of the present invention is a method for receiving a blockchain-based payment for sharing a data resource to at least two users, comprising the steps of receiving a notification, upon creation of a micropayment pool on the blockchain, to deliver the data resource to the at least two users; sharing a first portion of the data resource to a first user; receiving a first service receipt signed by the first user for the first portion of the data resource; sharing a second portion of the data resource to a second user; receiving a second service receipt signed by the second user for the second portion of the data resource; submitting the service receipts to a payment service module; receiving, from the payment service module, an updated off-chain transaction that accumulates a total payment amount including that for the first portion of the data resource and the second portion of the data resource; and submitting the off-chain transaction to the blockchain to claim the total payment from the micropayment pool.

In one embodiment, the method further comprises joining a peer group for sharing the data resource to the at least two users, and receiving a payment authorization certificate authorizing the sharing of the data resource to the first user and the second user.

In one embodiment, the method further comprises submitting the payment authorization certificate to the payment service module.

In one embodiment, the blockchain utilizes a validator committee of mining nodes to mine new blocks in a block settlement process. In one embodiment, the blockchain further utilizes guardian nodes to validate the blockchain at checkpoint blocks, in a block finalization process, and wherein the checkpoint blocks are a subset of blocks in the blockchain.

In one embodiment, the creation of the micropayment pool comprises submitting a funding transaction to the blockchain, and wherein the notification comprises a Merkle Proof of the funding transaction after has been included in a new block.

In one embodiment, the micropayment pool is associated with a resource ID for the data resource, a time-lock, and a slashable collateral.

According to another aspect, another embodiment of the present invention is a system for receiving a blockchain-based payment for sharing a data resource to at least two users, comprising at least one processor; and a non-transitory physical medium for storing program code accessible by the at least one processor. When executed by the processor, the program code causes the processor to receive a notification, upon creation of a micropayment pool on the blockchain, to deliver the data resource to the at least two users; share a first portion of the data resource to a first user; receive a first service receipt signed by the first user for the first portion of the data resource; share a second portion of the data resource to a second user; receive a second service receipt signed by the second user for the second portion of the data resource; submit the service receipts to a payment service module; receive, from the payment service module, an updated off-chain transaction that accumulates a total payment amount including that for the first portion of the data resource and the second portion of the data resource; and submit the off-chain transaction to the blockchain to claim the total payment from the micropayment pool.

In one embodiment, the program code when executed by the processor further causes the processor to join a peer group for sharing the data resource to the at least two users, and receive a payment authorization certificate authorizing the sharing of the data resource to the first user and the second user.

In one embodiment, the program code when executed by the processor further causes the processor to submit the payment authorization certificate to the payment service module.

In one embodiment, the blockchain utilizes a validator committee of mining nodes to mine new blocks in a block settlement process. In one embodiment, the blockchain further utilizes guardian nodes to validate the blockchain at checkpoint blocks, in a block finalization process, and wherein the checkpoint blocks are a subset of blocks in the blockchain.

In one embodiment, the creation of the micropayment pool comprises submitting a funding transaction to the blockchain, and wherein the notification comprises a Merkle Proof of the funding transaction after has been included in a new block.

In one embodiment, the micropayment pool is associated with a resource ID for the data resource, a time-lock, and a slashable collateral.

According to yet another aspect, yet another embodiment of the present invention is a non-transitory storage medium for storing program code for receiving a blockchain-based payment for sharing a data resource to at least two users, the program code executable by a processor, the program code when executed by the processor causes the processor to execute the steps as described herein.

Yet other aspects of the present invention include methods, processes, and algorithms comprising the steps described herein, and also include the processes and modes of operation of the systems and servers described herein. Other aspects and embodiments of the present invention will become apparent from the detailed description of the invention when read in conjunction with the attached drawings.

### BRIEF DESCRIPTION OF THE DRAWINGS

Embodiments of the present invention described herein are exemplary, and not restrictive. Embodiments will now be described, by way of examples, with reference to the accompanying drawings, in which:

FIG. 1 is a network diagram showing a traditional Content Delivery Network (CDN).

FIG. 2 is a network diagram for a traditional peer-to-peer streaming network.

FIG. 3 is a network diagram illustrating a hybrid network architecture combining peer-to-peer networking with a traditional CDN, according to one embodiment of the present invention.

FIG. 4A is an illustrative network diagram showing a decentralized data streaming and delivery network (“hybrid network”) with smart trackers and a payment server, according to one embodiment of the present invention.

FIG. 4B shows exemplary interactions among individual nodes within a hybrid network, in accordance with an embodiment of the invention.

FIG. 5 is a software architecture model diagram illustrating different components of a decentralized data streaming and delivery framework, in accordance with one embodiment of the present invention.

FIG. 6 is an exemplary schematic diagram of a user computing entity for implementing a viewer or caching node, according to exemplary embodiments of the present invention.

FIG. 7 is an exemplary schematic diagram of a management computing entity for implementing a server, according to exemplary embodiments of the present invention.

FIG. 8 is a diagram illustrating transactions through a resource-orientated micropayment pool, showing a viewer making off-chain payments to multiple edge cachers, according to some embodiments of the present invention.

FIG. 9 is another diagram illustrating transactions through a resource-orientated micropayment pool established by a content distributor, showing an edge casher receiving off-chain payments from multiple viewers, according to some embodiments of the present invention.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. In other instances, structures, devices, activities, and methods are shown using schematics, use cases, and/or flow diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon the invention.

THETA is a trademark name carrying embodiments of the present invention, and hence, the aforementioned trademark names may be interchangeably used in the specification and drawing to refer to the products/services offered by embodiments of the present invention. The term THETA may be used in this specification to describe the overall decentralized data streaming network or platform, the public ledger system for payment of bandwidth use or data content sharing, as well as the company providing said network, platform, or service. With reference to the figures, embodiments of the present invention are now described in detail.

### Overview

Broadly, embodiments of the present invention relate to methods and systems for resource-orientated, off-chain micropayment pools that facilitate ultra-high transaction throughput micropayments for blockchain-incentivized, decentralized data streaming and delivery through a distributed hybrid network. In particular, embodiments of the present invention enable blockchain-based cryptocurrency micropayments among multiple parties without the need to set up dedicated payment channels or payment routing networks. Off-chain transactions from one recipient to multiple source parties (“one-to-many”) and from multiple recipients to one source party (“many-to-one”) may be aggregated without the usual block confirmation latencies, and committed to the blockchain at a later time, without compromising privacy, security, and the no double-spent property of cryptocurrencies.

Various embodiments of the present invention are applicable, but not limited to, decentralized peer-to-peer data content delivery systems and platforms, which often focus on timely delivery of data content under strict, near real-time parameters. Peer nodes may function as end users as well as caching relays that source data content to nearby peers, and only connecting to a central content server when no geographically close-by peer sources are available. To incentivize end users to join as caching nodes for sharing redundant bandwidth and storage resources, and to encourage more active engagement with content platforms and content creators, a novel, decentralized public ledger system (hereafter the “THETA blockchain ledger system” or the “THETA blockchain”) is disclosed, where rewards or compensations for caching and relaying data content to peer users can be facilitated at very fine granularity, and support for content platforms and advertisers are enabled to drive new revenues while offloading content distribution costs.

More specifically, embodiments of the present invention relate to facilitating large quantities of one-to-many and many-to-one micropayments in cryptocurrency without incurring significant validation, confirmation, or settlement delays, by first establishing a micropayment pool on the THETA blockchain, authorizing a selected group of peers to share data contents, distributing service receipts for each chunk of data shared, then aggregating and accumulating individual service receipts for submission of a payment transaction to the THETA blockchain. In addition, some embodiments of the present invention incorporate a collateral to prevent double-spending, where the net value that a double spender gets is guaranteed to be strictly negative under all scenarios.

Compared with existing payment networks which require complex setup of bidirectional payment channels and/or intermediate exchanges, the ledger system according to the present invention provides a novel and innovative solution that significantly reduce latency and complexity, thus amplifying supportable throughput by several orders of magnitudes. In addition, by moving most micropayment transactions off-chain, embodiments of the present invention decrease the number of transactions stored in the blockchain, thus reducing storage space for maintaining the ledger system.

In what follows, a hybrid network infrastructure is first disclosed for peer-to-peer content distribution, and software architecture of individual nodes within the hybrid network are presented. Designs for the THETA blockchain ledger system, and micropayment pool and processing, are then disclosed. Hereinafter, video streaming is discussed in exemplary embodiments, for illustrative purpose only, without limiting the scope of the methods, systems, and devices as disclosed herein, which are capable of delivering other data content types with various reliability and latency requirements.

### Distributed Hybrid Network for Data Streaming and Delivery

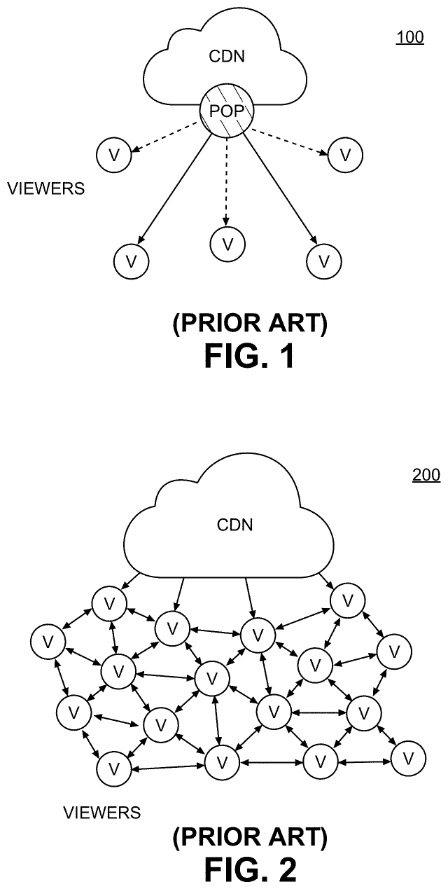

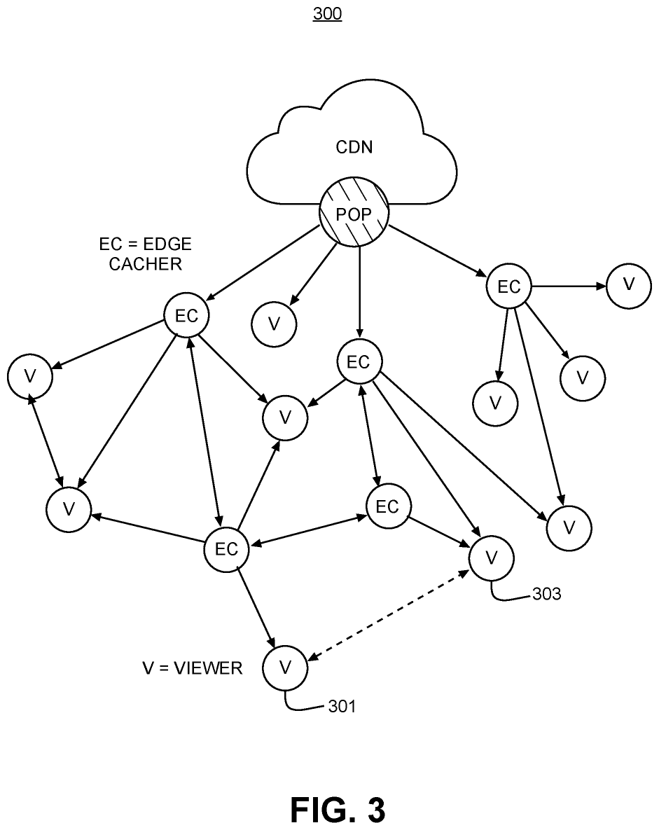

FIG. 1 is a network diagram showing a traditional content distributing network (CDN) 100, where individual viewers are connected to a CDN server directly via a Point-of-Presence (POP) data center. Viewer nodes are designated by the letter “V.” FIG. 2 is a network diagram for a traditional peer-to-peer streaming network 200. In the exemplary embodiments disclosed herein, viewers are representative of end users who receive and consume data content such as video and audio data streams.

Peer-to-peer (P2P) streaming often focuses on timely delivery of audio and video content under strict, near real-time parameters. P2P livestream delivery works best when many people tune in for the same stream at the same time. High concurrent user count means more peering resources are available, and thus peer nodes can pull data streams from each other more efficiently. Overall system capacity increases as more peer nodes become available. Moreover, robustness of the system is increased in a P2P network when compared to traditional CDNs, as nodes do not need to rely on a centralized server to retrieve content. This is especially important in cases of server failure. In contrast, for centralized CDN-based delivery as illustrated in FIG. 1, high number of concurrent users place scalability pressures on the CDN servers instead.

One shortcoming of pure P2P streaming is availability. Peers come and go at any time, which makes it difficult to predict the availability of any given peer node. There are also inherent differences and asymmetries in nodes, such as upload and download capacities. On the other hand, a CDN service is more reliable and robust, and hence it can serve as a reliable “backup” when requested data is not available from peer nodes.

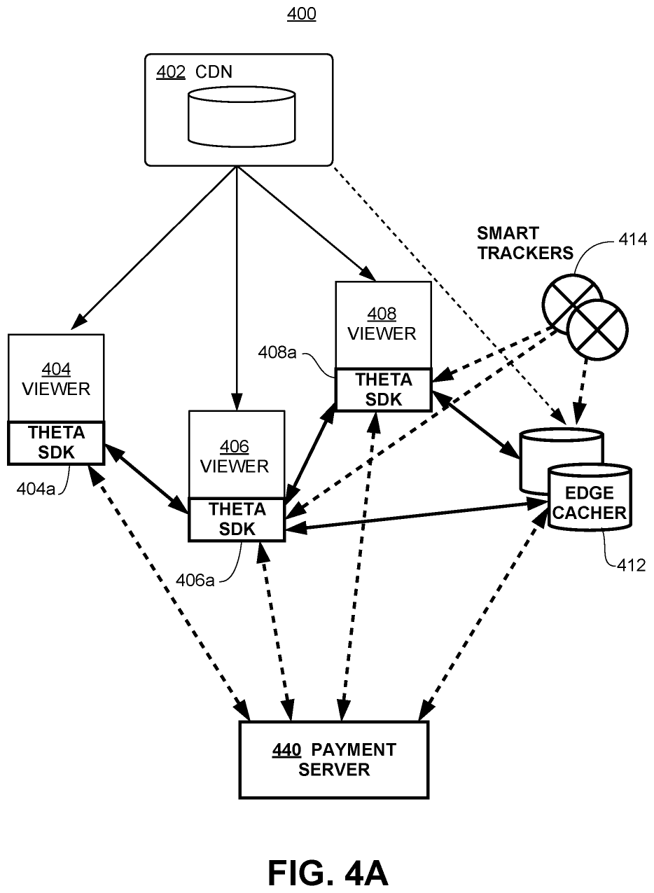

Taking advantage of both P2P networks and a CDN network, FIG. 3 shows a network diagram 300 of a decentralized data delivery “hybrid network” combining the two, according to one embodiment of the present invention. Within network 300, peer-to-peer connections among viewers (“V”) and edge cachers (“EC”) operate on top of an existing CDN, which itself comprises one or more point of presence (“POP”) servers. In this disclosure, a viewer is a network node that consumes delivered data, while an edge cacher is an intermediate relay that caches and/or relays data to neighboring peer nodes. Although individual nodes are labeled as either a viewer or an edge cacher in FIG. 3, a node may be both a viewer and an edge cacher node simultaneously as well. For example, the dashed line between viewers 301 and 303 on the edge of the network represents a data link over which each of nodes 301 and 303 may transmit cached data to the other.

Hybrid mesh streaming utilizes both P2P nodes (V and EC) and one or more CDN servers for data delivery, and thus combines the advantages of both, namely, high scalability of the P2P infrastructure along with the high availability of the CDN delivery backbone. One goal of this hybrid system is to achieve maximum CDN bandwidth reduction without sacrificing quality-of-service (QoS) critical to established streaming platforms such as NETFLIX, YOUTUBE, TWITCH, FACEBOOK and others. In traditional CDN 100 shown in FIG. 1, every node pulls data streams directly from the POP server. In hybrid network 300, whenever possible, peer nodes may pull data from each other instead of from the POP server. That is, only a subset of nodes pull data streams from the POP server; other nodes simply pull data streams from their peer caching nodes which provide better and more efficient connections. Caching nodes thus augment the traditional CDN backbones with more caching layers for end viewers geographically far away from POPs of the CDN backbones. This hybrid architecture applies to both video on demand and live streaming scenarios, as well as other data streaming and delivery setups.

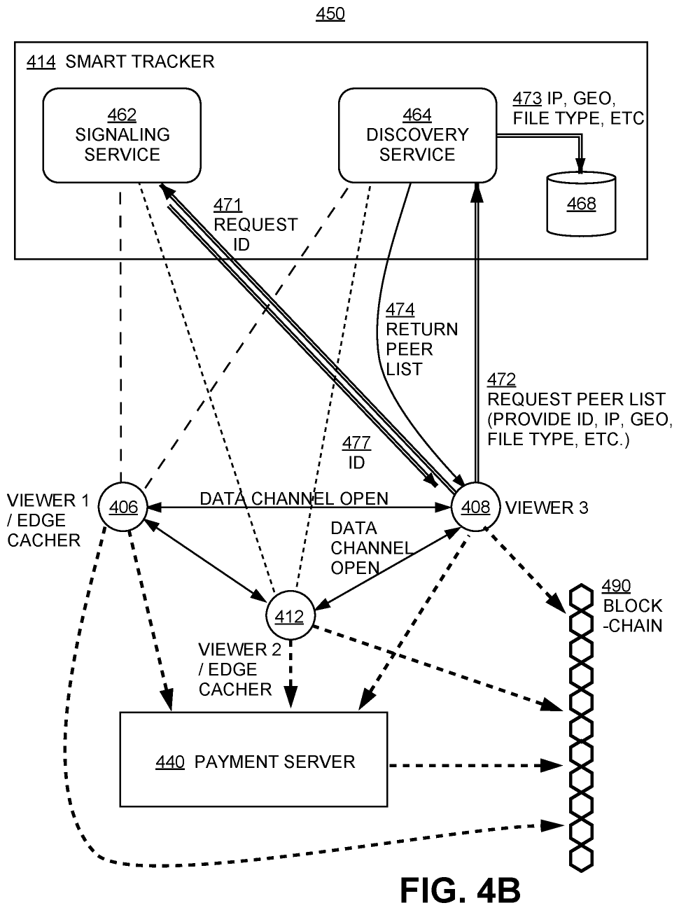

More specifically, FIG. 4A is an illustrative network diagram showing a decentralized, hybrid network 400, according to one embodiment of the present invention. In this illustrative example, hybrid network 400 comprises a CDN server or backbone 402, viewer nodes 404, 406 and 408, edge cacher 412, smart trackers 414, and a payment server 440. Viewers 404, 406, and 408, and edge cacher 412 are each connected directed to CDN 402, possibly through a POP server (not shown); viewers 404 and 406 are directly connected; viewers 406 and 408 are also directed connected, and both linked to edge cacher 412. In this hybrid structure, a viewer node may attempt to pull data from peers first, and only resort to downloading from CDN 402 as a failure-proof backup. In addition to dedicated edge cacher 412, each viewer node may serve as an edge cacher as well.

As discussed previously, P2P streaming focuses on timely delivery of data content under strict, near real-time parameters, while a traditional CDN architecture focuses on universal availability of content. Hybrid network 400 is designed to operate on top of an existing CDN which provides content to a plurality of peer nodes such as 404, 406, and 408. Although only one CDN server 402 is shown for simplicity, hybrid network 400 can operate with multiple CDN servers. Hybrid network 400 may also operate independently of CDN server 402 when sufficient number of peer nodes are operating within the network with sufficient amount of data.

In various embodiments, hybrid network 400 supports the transmission of various types of data content and files such as, but not limited to, live stream multimedia data, video-on-demand (VoD), large static data files, e.g., data blobs, system updates, game patches, advertisements, etc., and may be accessed and shared by peer nodes or viewer nodes 404, 406, and 408. In one example, different types of data may all be viewed as files, with each file divided into small fragments. Hybrid network 400 may store the fragments instead of entire files. Live streams may be viewed as files being generated and streamed at the same time. In one example, the viewers and edge cachers can support Web RTC (Real-Time Communications) HTTP/HTTPS protocols.

Accordingly, peer nodes 404, 406, and 408 may include different types of viewer and/or edge cacher clients capable of processing different data content types. Although FIG. 4A shows edge cacher 412 as separated from viewer nodes 404, 406, and 408, one or more of peer nodes 404, 406, and 408 may simultaneously implement an edge cacher as well as an end user software using a THETA Software Development Kit (SDK) such as 404a, 406a and 408a, so that a viewer may store and distribute content via P2P connections while also consuming the content. Unlike some streaming services that require proprietary content viewers such as video players to be installed, the THETA SDK may be integrated into a third-party application or device so that data content accessed by a peer node may be viewed or played within the third-party application. A Software Development Kit (SDK) is a set of software development tools or programming packages for creating applications for a specific platform. An SDK may be compiled as part of the developed application to provide dedicated interfaces and functionalities. Alternatively, an SDK may be an individually compiled module, incorporable into an existing application or player as a plug-in, add-on, or extension in order to add specific features to the application without accessing its source code.

In various embodiments, peer nodes 404, 406, and 408 may each implement different types of client software that enable different functionalities. A peer node 412 which implements an edge cacher may store fragments of the content, or slices within the fragments, to be delivered. The slices may be transmitted to requesting peers as needed. A peer node functioning as an edge cacher 412 may be viewed as having two local cache layers—a memory and a hard drive. Such a peer node 412 may implement a unified cache lookup strategy, where the memory is first accessed and a hard drive may then be accessed for retrieving the requested content. However, it may be noted that some clients may not have hard drive storage (such as a mobile phone), in which case edge cacher 412 may be implemented as a single local cache. Therefore, an abstracted cache interface may be enabled so that devices with or without hard drives can act as edge cacher nodes within hybrid network 400. Such nodes may be used to share live streams and concurrent VoD which are stored in memory. In the case of patch updates, a hard drive is typically required as the patch updates are stored on the hard drive.

The various content types supported by hybrid network 400 may have different delay or latency requirements. For example, livestreams require real-time or near real-time delivery, while VoD may require real-time delivery for the portion that a user is currently watching. Data blobs may not require real-time support, but download time needs to be minimized nonetheless. In order to support the relaying or propagation of large files, a “range request,” where a content fragment may be further divided into smaller slices and only a slice is requested and sent, may be supported in hybrid network 400. For example, CDN server 402 may support a range request even though the data blob may be provided as a complete large file.

Hybrid network 400 additionally includes one or more smart trackers 414 for managing the storage and consumption of content within hybrid network 400. Smart trackers 414 provide the intelligence that guides edge cacher 412 in storing and delivering data, and may handle unbounded number of live streams, VoD data, or data blobs concurrently. Smart trackers 414 may be implemented with a microservice architecture which comprises a signaling service 462 and a discovery service 464, as described in detail in relation to FIG. 4B.

Guided by smart trackers 414, cacher nodes (edge cachers and viewers) may self-organize into semi-randomly connected networks based on their geolocations. In an example, physical distances may be estimated and nodes within a certain threshold distance may be classified into networks based on their geolocations. For example, FIG. 4B shows a diagram of a smart tracker/discovery service for distributing data blobs/fragments among cacher nodes based on geolocations and other factors, in accordance with an embodiment of the invention.

Furthermore, peer nodes shown in FIG. 4A may be communicatively coupled to a payment server 440 which facilitates and manages payment transactions among viewers 404, 406, and 408 and edge cacher 412 when data contents are distributed as files or file segments. One or more instances of payment server 440 may be implemented in hybrid network 400, as a dedicated network node, or physically co-located with another network node, such as a CDN server 402, smart trackers 414, or any peer node within hybrid network 400. For example, payment server 440 may be co-located with smart tracker 414, where each is implemented as a software module. While smart tracker 414 determines P2P connections among peer nodes, based on factors such as geographical distances and resource availabilities, it may also determine payment authorization groups, where only members of a group may exchange payments for participating in P2P content distributions. In various embodiments, payment server 440 may be implemented as a stand-alone payment service software module, or as part of the THETA SDK. In the exemplary embodiment shown in FIG. 4A, peer nodes 404, 406, 408 and 412 are each individually connected to payment server 440. Additionally, in some embodiments, payment server 440 may be provided by a third-party, different from source CDN 402 as owned by a content distribution platform and end user viewer or caching nodes; in yet some embodiments, a content distribution platform may run payment server 440 itself.

FIG. 4B shows exemplary interactions among individual nodes within a hybrid network, such as hybrid network 400, in accordance with some embodiments of the present invention. In this network diagram 450, illustrative functionalities of network entities are shown. Peer nodes 406, 408, and 412 are each connected to a signaling service 462 and a discovery service 464 provided by smart tracker 414. Signaling service 462 facilitates handshakes between viewer 408 and viewer/edge cachers 406 and 412, for example, via the JavaScript Session Establishment Protocol (JSEP) based on the Web RTC standard. Discovery service 464 determines peers that are to be connected to each other based on various peer attributes such as, but not limited to, geolocations, file types or content types, Internet Protocol (IP) addresses, and so on.

In order to access content on the hybrid network, viewer 408 may initially transmit an ID request 471, such as via an HTTP request, to signaling service 462 for assignment of its own ID to be used within the hybrid network in order to access content. Signaling service 462 tracks active peer nodes, and may respond with ID 477 assigned to viewer 408. Viewer 408 then transmits ID 477 along with other attributes, such as its IP address, its geolocation, and file type requested, and a request for a peer list 472 of neighboring peer nodes that can serve the requested content. Discovery service 464 may then access a list of peers from a database 468 of smart tracker 414 based on the provided IP address, the geolocation, the file type requested, etc. 473. Discovery service 464 may then select and return a peer list 474 comprising one or more peer nodes, such as viewer 406 and viewer 412, both serving as edge cacher nodes in this example, to which the viewer 408 may connect in order to access the requested content.

In this embodiment, signaling service 462 and discovery service 464 are co-located within the same smart tracker 414. ID 477 for viewer 408 may be communicated by signaling service 462 to discovery service 464 directly, and discovery service 464 may respond to viewer 408 with the selected peer node list 474 and ID 477. In some embodiments, discovery service 464 may transmit attributes of the selected peer nodes in peer list 474, e.g., attributes of viewer 406 and viewer 412, such as their IP addresses, so that viewer 408 can transmit the content/slice requests to peer cacher nodes 406 and 412, and at their corresponding IP addresses. Viewer 408 thus employs ID 477 to obtain information necessary to open data channels directly with viewer 406 and/or viewer 412 to receive the content. Data channels between the peer nodes may persist until the data sharing/relaying operation is completed. In addition, any payment transactions between viewer 408, and the edge cachers 406 and 412 may be handled by payment server 440, including micropayments for individual content fragments or slices.

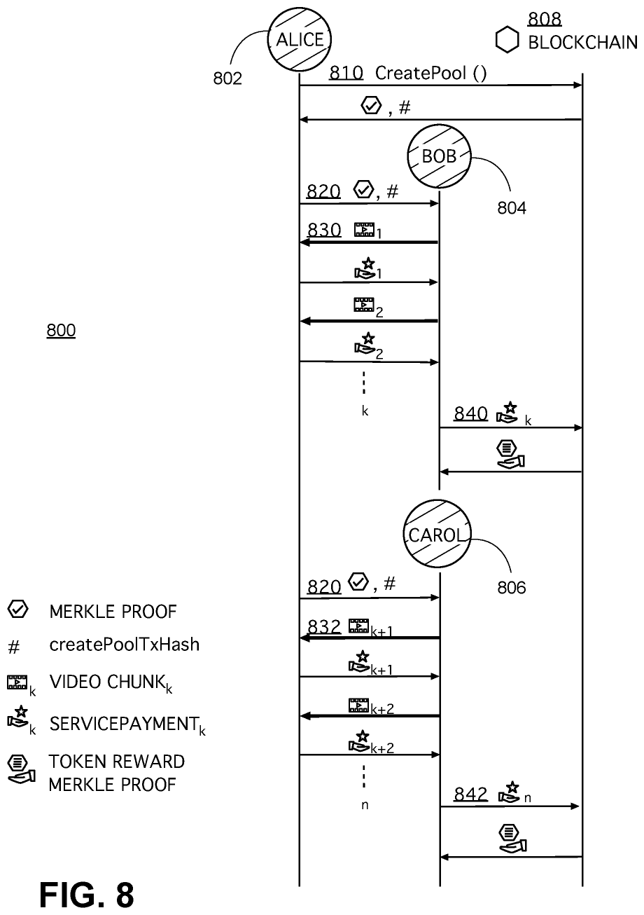

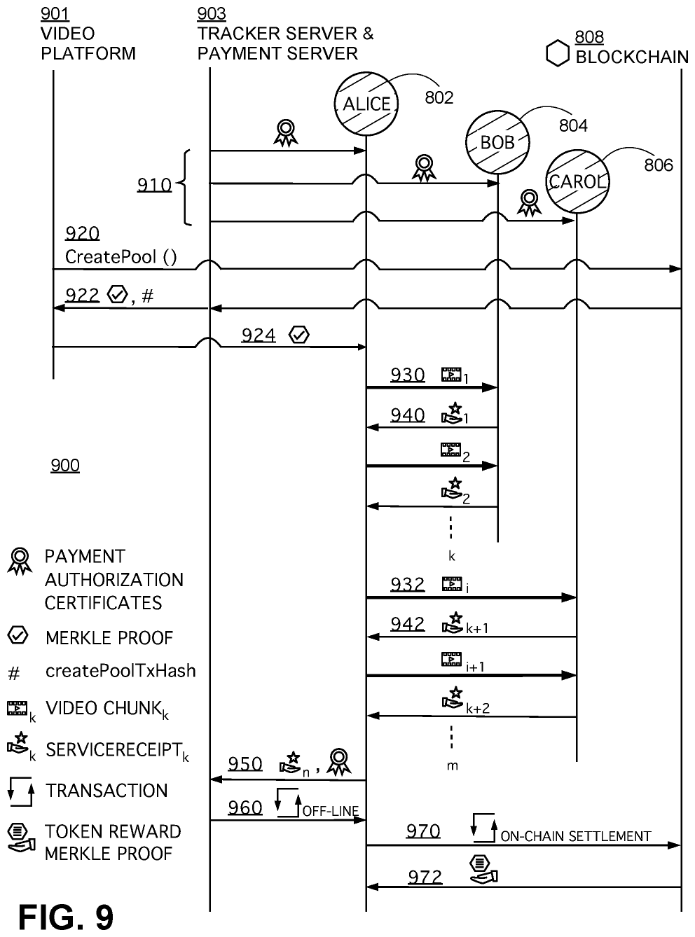

In this exemplary embodiment, each peer node 406, 408, and 412, as well as payment server 440 have access to a public blockchain ledger 490, namely the THETA blockchain. The THETA blockchain provides THETA tokens as a form of cryptocurrency incentive to edge cachers in the hybrid network. More details on the THETA blockchain are disclosed with reference to FIGS. 8 and 9.

In some embodiments, each edge cacher may further include a stats service, an authenticity service, and a private Application Programming Interface (API) service. The authenticity service may provide a hash of each data fragment in case CDN server 402 does not provide etags. The private API service may provide access to private APIs for functions such as publishing content, configuration changes, force publishing content, and the like.

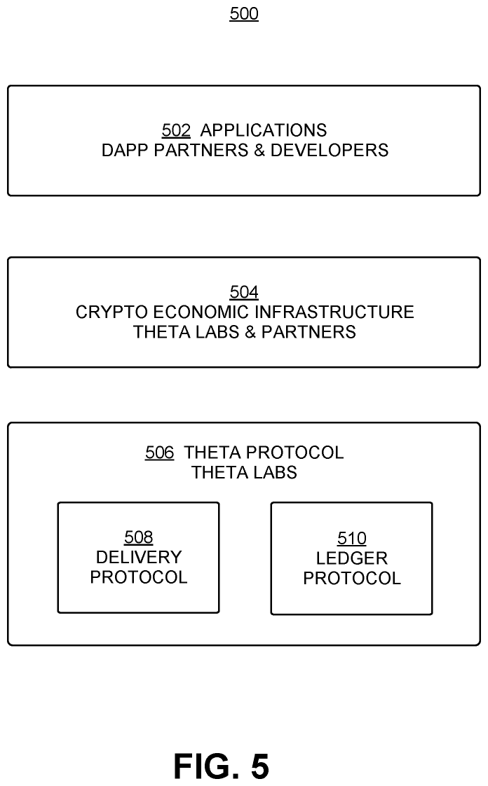

FIG. 5 is a software architecture model diagram 500 illustrating different layers of a decentralized data streaming and delivery framework, in accordance with some embodiments of the present invention. An applications layer 502 may comprise user interfaces (UIs) and program codes implementing application-level program logic consistent with user expectations of the applications, a THETA JavaScript mesh streaming library to build hybrid network 400, and a THETA SDK used for integration of the applications with existing viewers/players/devices.

Crypto economic infrastructure 504 covers a payment processes implementation within hybrid network 400, including payment server 440, which facilitates payments among viewers and edge cachers such as 402, 406, 408 and 412. A set of API/libraries may be provided for developers to build crypto wallets, including the client side and the server side software infrastructures. A cacher software/library may also be provided for building a WebRTC-based desktop client.

THETA protocol layer 506 comprises a delivery protocol 508 and a ledger protocol 510. The delivery protocol 508 may support a smart tracker server which determines the streaming method/bandwidth sharing strategy between peers 404, 406, 408, and 412 in hybrid network 400. Ledger protocol 510 may comprise consensus mechanisms, on-chain and off-chain transaction construction and handling rules, and other communication and cryptographic protocols that define the THETA blockchain-based ledger system.

### Implementation Using Computer Program Products, Methods, and Computing Entities

### Exemplary System Architecture

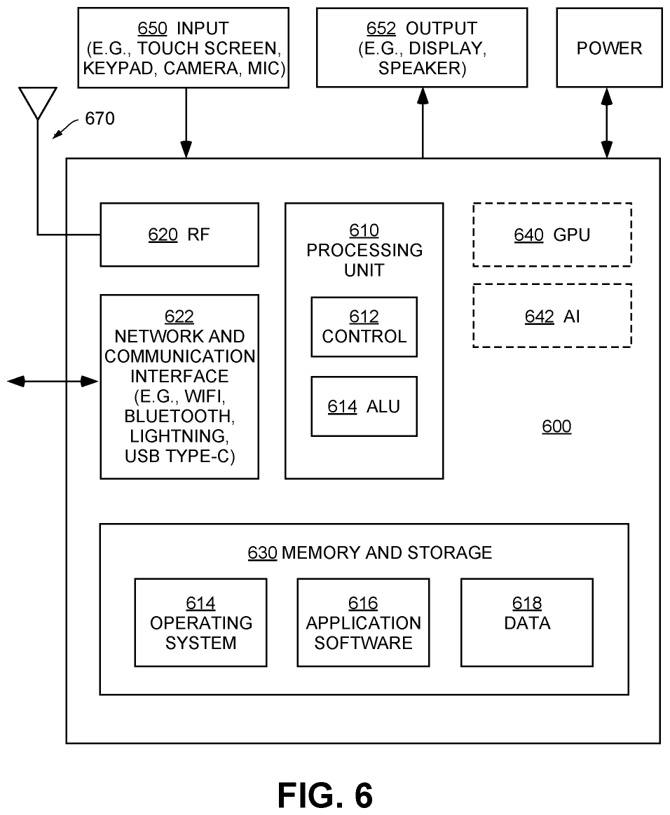

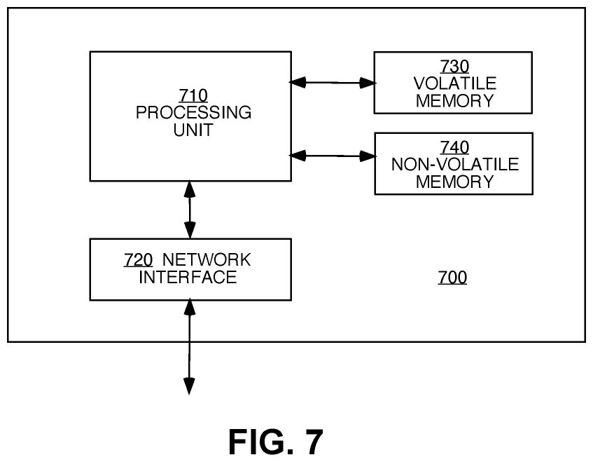

An exemplary embodiment of the present disclosure may include one or more end user computing entities 600, one or more networks, and one or more CDN, tracker server, payment server, or other management computing entities 700, as shown in FIGS. 6 and 7. Each of these components, entities, devices, systems, and similar words used herein interchangeably may be in direct or indirect communication with, for example, one another over the same or different wired or wireless networks. Additionally, while FIGS. 6 and 7 illustrate the various system entities as separate, standalone entities, the various embodiments are not limited to this particular architecture.

### Exemplary User Computing Entity

FIG. 6 is an exemplary schematic diagram of an end user computing device for implementing a viewer node or a cacher node, according to exemplary embodiments of the present invention. An end user computing device 600 capable of viewing or caching streamed video includes one or more components as shown. As will be recognized, these architectures and descriptions are provided for exemplary purposes only and are not limiting to the various embodiments.

In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, retrieving, operating on, processing, displaying, storing, determining, creating, generating, monitoring, evaluating, comparing, and/or similar terms used herein interchangeably. In various embodiments, these functions, operations, and/or processes can be performed on data, content, information, and/or similar terms used herein interchangeably. On the other hand, a content, tracker, or payment server may be implemented according to the exemplary schematic diagram shown in FIG. 7, possibly in the cloud, and possibly with logically or physically distributed architectures.

As shown in FIG. 6, user computing entity 600 may include an antenna 670, a radio transceiver 620, and a processing unit 610 that provides signals to and receives signals from the transceiver. The signals provided to and received from the transceiver may include signaling information in accordance with air interface standards of applicable wireless systems. In this regard, user computing entity 600 may be capable of operating with one or more air interface standards, communication protocols, modulation types, and access types. More particularly, user computing entity 600 may operate in accordance with any of a number of wireless communication standards and protocols. In some embodiments, user computing entity 600 may operate in accordance with multiple wireless communication standards and protocols, such as 5G, UMTS, FDM, OFDM, TDM, TDMA, E-TDMA, GPRS, extended GPRS, CDMA, CDMA2000, 1×RTT, WCDMA, TD-SCDMA, GSM, LTE, LTE advanced, EDGE, E-UTRAN, EVDO, HSPA, HSDPA, MDM, DMT, Wi-Fi, Wi-Fi Direct, WiMAX, UWB, IR, NFC, ZigBee, Wibree, Bluetooth, and/or the like. Similarly, user computing entity 600 may operate in accordance with multiple wired communication standards and protocols, via a network and communication interface 622.

Via these communication standards and protocols, user computing entity 600 can communicate with various other computing entities using concepts such as Unstructured Supplementary Service Data (USSD), Short Message Service (SMS), Multimedia Messaging Service (MIMS), Dual-Tone Multi-Frequency Signaling (DTMF), and/or Subscriber Identity Module Dialer (SIM dialer). User computing entity 600 can also download changes, add-ons, and updates, for instance, to its firmware, software (e.g., including executable instructions, applications, program modules), and operating system.

In some implementations, processing unit 610 may be embodied in several different ways. For example, processing unit 610 may be embodied as one or more complex programmable logic devices (CPLDs), microprocessors, multi-core processors, coprocessing entities, application-specific instruction-set processors (ASIPs), microcontrollers, and/or controllers. Further, the processing unit may be embodied as one or more other processing devices or circuitry. The term circuitry may refer to an entirely hardware embodiment or a combination of hardware and computer program products. Thus, processing unit 610 may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit 610 may be configured for a particular use or configured to execute instructions stored in volatile or non-volatile media or otherwise accessible to the processing unit. As such, whether configured by hardware or computer program products, or by a combination thereof, processing unit 610 may be capable of performing steps or operations according to embodiments of the present invention when configured accordingly.

In some embodiments, processing unit 610 may comprise a control unit 612 and a dedicated arithmetic logic unit 614 (ALU) to perform arithmetic and logic operations. In some embodiments, user computing entity 600 may optionally comprise a graphics processing unit 640 (GPU) for specialized image and video rendering tasks, and/or an artificial intelligence (AI) accelerator 642, specialized for applications including artificial neural networks, machine vision, and machine learning. In some embodiments, processing unit 610 may be coupled with GPU 640 and/or AI accelerator 642 to distribute and coordinate processing tasks.

In some embodiments, user computing entity 600 may include a user interface, comprising an input interface 650 and an output interface 652, each coupled to processing unit 610. User input interface 650 may comprise any of a number of devices or interfaces allowing the user computing entity 600 to receive data, such as a keypad (hard or soft), a touch display, a mic for voice/speech, and a camera for motion or posture interfaces. User output interface 652 may comprise any of a number of devices or interfaces allowing user computing entity 600 to provide content and information to a user, such as through a touch display, or a speaker for audio outputs. In some embodiments, output interface 652 may connect user computing entity 600 to an external loudspeaker or projector, for audio or visual output.

User computing entity 600 may also include volatile and/or non-volatile storage or memory 630, which can be embedded and/or may be removable. A non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store an operating system 614, application software 616, data 618, databases, database instances, database management systems, programs, program modules, SDKs, scripts, source code, object code, byte code, compiled code, interpreted code, machine code, executable instructions, and/or the like to implement the functions of user computing entity 600. As indicated, this may include a user application that is resident on the entity or accessible through a browser or other user interface for communicating with a management computing entity and/or various other computing entities.

In some embodiments, user computing entity 600 may include location determining aspects, devices, modules, functionalities, and/or similar words used herein interchangeably. For example, user computing entity 600 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites. Alternatively, the location information may be determined by triangulating the user computing entity's position in connection with a variety of other systems, including cellular towers, Wi-Fi access points, and/or the like. Similarly, user computing entity 600 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters. Location information thus obtained may be used in determining nearby peers for data distribution and retrieval.

In some embodiments, two or more users may establish a connection between their computing devices using any of the networking protocols listed previously, and any peer-to-peer protocols including BitTorrent, or that provided by the THETA hybrid network. In some embodiments, the user computing devices may use a network interface such as 622 to communicate with various other computing entities, to exchange data content, information, and/or similar terms used herein interchangeably that can be transmitted, received, operated on, processed, displayed, stored, and/or the like.

In some embodiments, data (e.g., audio, video, etc.) may be downloaded by one or more user computing devices to a server such as shown in FIG. 7 when the device accesses a network connection, such as a wireless access point or hotspot. The data transfer may be performed using protocols like file transfer protocol (FTP), MQ telemetry transport (MQTT), advanced message queuing protocol (AMQP), hypertext transfer protocol (HTTP), and HTTP secure (HTTPS). These protocols may be made secure over transport layer security (TLS) and/or secure sockets layer (SSL).

### Exemplary Management Computing Entity

FIG. 7 is an exemplary schematic diagram of a management computing entity 700, such as a CDN or tracker server, for implementing the THETA network, according to exemplary embodiments of the present invention. The terms computing entity, computer, entity, device, system, and/or similar words used herein interchangeably are explained in detailed with reference to user computing entity 600.

As indicated, in one embodiment, management computing entity 700 may include one or more network or communications interface 720 for communicating with various computing entities, such as by communicating data, content, information, and/or similar terms used herein interchangeably that can be transmitted, received, operated on, processed, displayed, stored, and/or the like. For instance, management computing entity 700 may communicate with user computing device 600 and/or a variety of other computing entities. Network or communications interface 720 may utilized a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, management computing entity 700 may be configured to communicate via wireless external communication networks using any of a variety of standards and protocols as discussed with reference to user computing device 600.

As shown in FIG. 7, in one embodiment, management computing entity 700 may include or be in communication with one or more processing unit 710 (also referred to as processors, processing circuitry, processing element, and/or similar terms used herein interchangeably) that communicate with other elements within the management computing entity 700. As will be understood, processing unit 710 may be embodied in a number of different ways. For example, as one or more CPLDs, microprocessors, multi-core processors, coprocessing entities, ASIPs, microcontrollers, and/or controllers, in the form of integrated circuits, application specific integrated circuits (ASICs), field programmable gate arrays (FPGAs), programmable logic arrays (PLAs), hardware accelerators, other circuitry, and/or the like. As will therefore be understood, processing unit 710 may be configured for a particular use or configured to execute instructions stored in volatile or non-volatile media 730 and 740. As such, whether configured by hardware or computer program products, or by a combination thereof, processing unit 710 may be capable of performing steps or operations according to embodiments of the present disclosure when configured accordingly.

Although not shown explicitly, management computing entity 700 may include or be in communication with one or more input elements, such as a keyboard, a mouse, a touch screen/display, a camera for motion and movement input, a mic for audio input, a joystick, and/or the like. Management computing entity 700 may also include or be in communication with one or more output elements such as speaker, screen/display, and/or the like.

In various embodiments, one or more of the components of management computing entity 700 may be located remotely from other management computing entity components, such as in a distributed system or in the cloud. Furthermore, one or more of the components may be combined and additional components performing functions described herein may be included in the management computing entity 700.

### THETA Blockchain-Based Ledger System

To encourage and incentivize peer nodes to contribute their computing, bandwidth, and storage resources, a payment or reward system may be setup, where caching nodes earn rewards as they relay video stream to other viewers. Such a payment system may also greatly improve the streaming market efficiency, by allowing advertisers to engage viewers directly, and by providing streaming and content platforms with new and incremental revenue opportunities.

While traditional payment processing solutions may be considered for facilitating the above mentioned reward system, a secure and minimally delayed alternative that is naturally compatible with decentralized data streaming and delivery is a decentralized, distributed, public ledger payment service system, for example, based on a blockchain. A blockchain is a list of public transaction records, or blocks, linked through cryptography, and typically managed by a peer-to-peer network with protocols for inter-node communication and block validations. While conventional payment systems require a central authority to verify and clear transactions to maintain trust, a blockchain ledger system achieves global, decentralized consensus without such a central authority. A blockchain is immutable, where modifications to transaction data is near impossible, a property making it suitable for use by cryptocurrencies as a payment method in the above mentioned reward system.

Specifically, a blockchain-based public ledger system is a decentralized, public database of transactions, which are records that encode the transfer of value from one user to another. Transactions are bundled into blocks, and each block is validated through a cryptographic computational process called mining, and based on a set of consensus rules followed by all nodes of the blockchain network.

Unlike centralized video streaming platforms where viewers pay directly into a central server in the form of a subscription or on a pay-per-view basis, the alternative of compensating multiple peers each providing small segments of video data to multiple other peers in a peer-to-peer network presents a significant scaling problem. Typical video segments are only a few seconds long, and to pay at such granularity, for a live stream with even just a moderate number of ten thousand concurrent viewers could generate thousands of transactions per second, far exceeding the maximum throughput of today's public blockchains. Popular live streams like major esport tournaments can attract more than one million viewers watching one stream simultaneously, not to mention multiple concurrent live streams, which could potentially push the required transaction throughput further to the range of millions per second.

To overcome the above mentioned difficulties, a novel, decentralized public ledger system, the THETA blockchain based ledger system, is proposed and implemented for decentralized data streaming and delivery. For example, blockchain 490 shown in FIG. 4B may be implemented on a THETA token mining network according to the THETA protocol, which builds upon the following three novel designs.

First, a multi-level Byzantine Fault Tolerant (BFT) consensus mechanism is employed, allowing thousands of nodes to participate in the consensus process while still supporting very high transaction throughput, for example, in the range of 1,000+ transactions per second. Data streaming applications typically require fast consensus. For bandwidth sharing rewards, users who contribute redundant bandwidth typically want the payment to be confirmed before sending the next data segment. To minimize transaction confirmation delays, the THETA protocol uses a small set of nodes to form a validator committee, producing a chain of blocks as fast as possible using a practical BFT (PBFT)-like process. With a sufficient number of validators such as 10 to 20 nodes, the validator committee may produce blocks at a fast speed, while still retaining a high degree of difficulty to prevent an adversary from compromising the integrity of the blockchain. A transaction is “committed” once it is included in a new block. To be eligible to join the validator committee, a node may lock up a certain amount of stake for a period of time. The locked stake could be slashed if malicious behavior is detected. The blocks that the committee reaches consensus on are called settled blocks, and the process by which they produce a chain of blocks is called the block settlement process.

Next, thousands of consensus participants called guardian nodes may validate and finalize the chain generated by the validator committee at checkpoint blocks. The guardian network is a super set of the validator committee, where a validator is also a guardian. With a certain amount of token lockup for a period of time, any node in the network may instantly become a guardian. The guardians may download and examine the chain of blocks generated by the validator committee and try to reach consensus on the checkpoints. “Finalization” refers to convincing each honest guardian that more than a certain portion (e.g., ⅔) of all the other guardians see the same chain of blocks. Blocks that the guardian nodes have reached consensus on are called finalized blocks, and the process by which they finalize the chain of blocks is called the block finalization process. Checkpoint blocks are a selected subset of blocks that satisfy a given set of conditions, for example, whose height are a multiple of some integer. This “leapfrogging” finalization strategy leverages the immutability characteristic of the blockchain data structure, where as long as two guardian nodes agree on the hash of a block, with overwhelming probability, they will have exactly the same copy of the entire blockchain up to that block. The validator/guardian division provides multiple levels of security guarantee. The validator committee provides a first level of consensus and the guardian pool forms a second line of defense. With thousands of nodes, it is substantially more difficult to compromise the integrity of the network, and thus provides a much higher level of security. This consensus mechanism achieves a good balance among transaction throughput, consistency, and level of decentralization.

Second, the THETA blockchain uses an aggregated signature gossip scheme to significantly reduce messaging complexity. Each guardian node keeps combining partially aggregated signatures from all its neighbors, and then gossips out the aggregated signature. This way the signature share of each node can reach other nodes at an exponential rate. In addition, signature aggregation keeps the size of the node-to-node messages small, and thus further reduces communication overhead.

Third, the THETA blockchain offers an off-chain “Resource-Orientated Micropayment Pool” for data content streaming and delivery. An off-chain micropayment pool enables one-to-many and many-to-one payments using off-chain transactions. For video streaming, a viewer can pay for video content pulled from multiple cachers, and a cacher can be paid for delivering video data to multiple viewers, all with only limited number of on-chain transactions. Moving significant amount of transactions off-line can significantly improve the scalability of the blockchain.

Furthermore, the THETA ledger system according to the present invention addresses several challenges unique to data streaming applications.

First, the present invention supports ultra-high transaction throughput. While many blockchain projects are facing transaction throughput problems, scaling for live video streaming is different and possibly even more complex. At the granularity of a token reward micropayment per video segment, for popular esport tournaments where multiple live streams often are established with millions of concurrent viewers, millions of micro-transactions can be generated per second, far exceeding the maximum throughput of today's public chains, such as Bitcoin and Ethereum. New generations of blockchain solutions like DFINITY and ZILLIQA are reported to handle thousands or even tens of thousands of on-chain transactions per second. Yet millions of transactions per second is still a far-fetched goal for these other systems. To get closer, level-two scalability solutions such as payment networks may be one option to pursue. A payment network refers to a class of techniques designed to allow users to make multiple transactions without committing all of the transactions to the blockchain, and to improve the scalability of the underlying blockchain. Nonetheless, such payment networks rely on underlying payment channels and/or intermediate exchanges, as well as dedicated payment routing paths, with cumulative latencies and complexities. Instead, the ledger system according to the present invention provides a novel and innovative solution in the form of off-chain scaling via a “resource oriented micropayment pool,” which amplifies the supportable throughput by several order of magnitudes.

Second, a byproduct of high transaction throughput is rapidly growing storage consumption, and storing micropayment transactions is highly storage demanding. With millions of transactions added to a ledger every second, the storage space of an ordinary computer could run out quickly. The present invention decreases the number of transactions need to be stored in the blockchain by moving most micropayment transactions off-chain.

Third, the present invention may incorporates a collateral to prevent double-spending. That is, the present invention may detect double spending, and ensure that the net value that a double spender gets is strictly negative under all scenarios. In some embodiments, micropayment may be made without trust, with the maximum risk being the loss of a very limited number of micropayments such as that for a single packet of data.

In what follows, payment channels and payment networks are first described to highlight their advantages and disadvantages for use in high transaction throughput P2P data streaming. The resource orientated, off-chain micropayment pool is disclosed in the next subsection.

### Payment Channels and Payment Networks

A payment channel is a class of existing mechanisms that allow users to exchange multiple transactions without committing to the blockchain. Such “off-line” transactions can be settled on the blockchain later, thus incurring minimal transaction confirmation latencies. A payment channel is a type of a state channel, where a state shared between two users is locked onto the blockchain through a funding transaction first, and where the state is a cryptocurrency amount or balance. Subsequent commitment transactions are exchanged off-line between the two users to update the initial state. A final settlement transaction unilaterally or bilaterally closes the state channel when submitted to the blockchain for confirmation. As state updates or commitment transactions can be exchanged between the users off-line, as soon as they are created and signed, many more transactions can be exchanged in-between the funding and the settlement transactions. Cutting the number of on-chain transactions down to two also drastically reduces the costs associated with very frequent micropayments.

As a simple, illustrative example of payment channels, consider a case where Alice wants to buy a food item from Bob everyday using crypto tokens for a month. Since Alice needs to pay a transaction fee for each token transaction, she prefers a single lumped payment to Bob at the end of the month, yet Bob prefers one token transaction for each food item, as he does not have full trust that Alice would pay the lump-sum payment at the end of the month.

A payment channel is a viable option to break the deadlock. On day one, Alice may deposit 30 tokens into a separate wallet W, which only allows Bob to withdraw from it, by requiring transaction signatures from both Alice and Bob. After this deposit transaction is recorded on the blockchain, Bob confirms that Alice has reserved a sufficient number of tokens to pay him for the entire month, and he is the only one allowed to withdraw from this wallet. On day n (1≤n≤30), Bob gives Alice a food item, and gets a partially signed commitment transaction in return, where the transaction assigns n tokens to Bob and the remaining 30-n tokens as a change back to Alice. Bob can thus sign and publish the latest commitment transaction received from Alice as a settlement on the blockchain, on any day m to claim m-1 or m tokens, depending on whether the latest settlement transaction has been signed by Alice for the m-th food item. Once settled, the deposit fund is depleted, with m tokens sent to Bob and the remaining sent back to Alice. If the daily purchase process continues until day 30, Bob can sign the last transaction from Alice and submit it to the blockchain to claim all of the 30 tokens from wallet W all at once. Thus, Bob does not need to worry about Alice not paying for any of the food items, and Bob is incentivized to submit only the last transaction to the blockchain, as it gives him the most tokens. In addition, Alice cannot cheat by publishing any of these transactions since it requires both Alice and Bob's signatures.

Thus, a payment channel can significantly improve the scalability of the blockchain since it reduces the number of on-chain transactions. In the example above, it reduces the number of on-chain transactions from 30 to 2. The above example is a simplified illustration of a unidirectional payment channel. A practical payment channel needs more customization like a time-lock, and related functionalities.

When food items in the above example are replaced with video segments, with a payment channel, a viewer can pay for many video segments with just one on-chain settlement transaction. Nonetheless, two issues need to be taken into consideration. First, slow node switching times are unconducive to streaming data segments from multiple cachers to multiple viewers. As discussed above, an on-chain transaction is needed to establish a payment channel between any two parties, which might take at least a couple seconds to be confirmed on the blockchain. Typically, in a live stream session (one or two hours long), a viewer node may pull stream segments from 10+ caching relay nodes. Each time the viewer needs to pull a stream from a new relay or caching node, it needs to make an on-chain transaction first, which is time consuming. In addition, before the on-chain transaction is confirmed, the viewer node cannot pull streams from the caching/relay node. This could halt the video stream, leading to degraded user experience. Second, large amounts of tokens are required to be reserved. Each payment channel requires a certain number of tokens reserved upfront. Thus, creating 10+ payment channels from a viewer to multiple relay nodes, or from multiple viewers to one relay may not always be feasible, especially if a viewer doesn't have enough tokens. As a result, a viewer may not be able to pull from peer nodes even if the peer caching nodes have the desired stream segment, leading to underutilization of the network and less savings for content distribution platforms.

In addition to creating direct payment channels between viewer-relay pairs, off-chain “payment networks” may be employed to route payments through intermediate parties. For example, the Lightning Network is a network of bidirectional payment channels that allows payment to be routed from one payment channel to the next, without trusting the intermediate peers. However, routing through a payment channel network involves discovering indirect routes between a viewer and a cacher, yet such indirectly routes may not always exist. Even when an indirect route does exist between the viewer and the cacher, sending micropayments through extra hops adds latency and complexity.

### Resource-Orientated Micropayment Pool for Decentralized Data Streaming and Delivery

To avoid the aforementioned issues associated with payment channels and payment channel networks when incentivizing peer nodes to participate in decentralized, P2P data streaming and delivery, a novel “Resource-Oriented Micropayment Pool” can be built, to and from which multiple users can deposit or withdraw using off-chain transactions, while providing double-spend protection. That is, although a viewer and a cacher may be connected for data transmission, when incentivized by a blockchain-based cryptocurrency, both may also connect to a payment server and/or the blockchain for payment settlement, and some peer nodes for possibly routing micropayments. This setup was illustrated in FIG. 4B. Within the THETA blockchain ledger framework, a micropayment pool as disclosed facilitates micropayments among multiple parties without requiring a connected payment network.

### One-to-Many Micropayment Processing for Multi-Source Data Streaming and Delivery

As discussed previously, in a typical live stream session, a viewer node may pull data stream segments from multiple relay or caching nodes. With a one-to-many micropayment pool, the viewer does not need to specify which accounts can withdraw ahead of time when the micropayment pool was created. Such a system is much more flexible compared to conventional off-chain payment channels. In particular, for decentralized video streaming and delivery, it allows a viewer to pay for video content pulled from multiple caching nodes without intermediate on-chain transactions and without maintaining payment connections with each individual caching node. By replacing on-chain transactions with off-chain payments, the built-in “Resource-Oriented Micropayment Pool” significantly improves the scalability of the blockchain.

FIG. 8 is a diagram 800 illustrating transactions through a resource-orientated micropayment pool, showing a viewer 802 Alice making off-chain payments to cachers 804 Bob and 806 Carol for video chunks. In this particular example, the following steps are performed.

Step 1. Micropayment Pool Creation:

Alice publishes an on-chain transaction to create a micropayment pool with a time-lock and a slashable collateral, possibly using the following command 810:
CreatePool(resourceId, deposit, collateral, duration)

To create the pool, Alice may specify a “Resource ID” resourceId that uniquely represents the digital content she intends to retrieve. It may refer to a video file, or a live stream. The deposit amount may be at least the total value of the resource to be retrieved. For instance, if the resource is a video file which is worth 10 tokens, then the deposit has to be at least 10 tokens. The collateral discourages Alice from double spending. If a double spending attempt from Alice is detected by validators of the blockchain, the collateral can be slashed. It will be discussed in a later section that if collateral>deposit, the net return of a double spend is always negative, and hence any rational user will have no incentive to double spend. The duration is a time-lock similar to that of a standard payment channel. Any withdrawal from the payment pool has to be before the time-lock expires. The blockchain returns Alice the Merkle proof of the CreatePool transaction after it has been committed to the blockchain, as well as createPoolTxHash, the transaction hash of the CreatePool transaction.

Step 2. Initial Handshake Between Peers:

Whenever Alice wants to retrieve the specified resource from a peer (e.g., Bob, Carol, or David, etc.), she sends 820, the Merkle proof and transaction hash of on-chain CreatePool transaction 810 to that peer. The recipient peer may verify the Merkle proof to ensure that the pool has sufficient deposit and collateral for the requested resource, and both parties can proceed to the next steps.

Step 3. Off-Chain Micropayments:

Alice signs ServicePayment transactions and sends them to the peers off-chain in exchange for parts of the specified resource (e.g., a piece of a video file, a live stream segment, etc.). A ServicePayment transaction may contain the following data:
targetAddress, transferAmount, createPoolTxHash, targetSettlementSequence, Sign(SK_{A}, targetAddress ∥ transferAmount ∥ createPoolTxHash ∥ targetSettlementSequence).
   targetAddress is the address of the peer that Alice retrieves the resource from, and transferAmount is the amount of token payment Alice intends to send. targetSettlementSequence is to prevent a replay attack. It is similar to the “nonce” parameter in an Ethereum transaction. If a target publishes a ServicePayment transaction to the blockchain (see the next step), its targetSettlementSequence needs to increment by one. The recipient peer verifies the off-chain transactions and the signatures. Upon validation, the recipient peer can send Alice the resource 830 or 832 specified by the CreatePool transaction. Also, the off-chain ServicePayment transactions may be sent directly between two peers. Hence there is no scalability bottleneck for this step.

Step 4. On-Chain Settlement:

Any peer (i.e. Bob, Carol, or David, etc.) that receives the ServicePayment transactions 840 or 842 from Alice can publish the signed transactions to the blockchain any time before the timelock expires to withdraw the tokens. ServicePayment transactions that are published a may also be called “on-chain settlement” transactions. The recipient peers need to pay for the gas fee for the on-chain settlement transaction. To pay less transaction fees, they would have the incentive to publish on-chain settlements only when necessary, which is beneficial to the scalability of the network.

Note that no new on-chain transaction is needed when Alice switches from one peer to another to retrieve the resource. In the video streaming context, this means a viewer can switch to any caching node at any time without making an on-chain transaction that could potentially block or delay the video stream delivery. As shown in FIG. 8, in the event that Bob leaves, Alice can switch to Carol after receiving k chunks from Bob, and keep receiving video segments without an on-chain transaction.

Moreover, the total number of tokens needed to create the micropayment pool is (collateral+deposit), which can be as low as twice of the value of the requested resource, no matter how many peers Alice retrieves the resource from. Using computational complexity language, the amount of reserved token reduces from O(n) to O(1) compared to the unidirectional payment channel approach, where n is the number of peers Alice retrieves the resource from.

### Double Spending Detection and Penalty Analysis

As with any cryptocurrency, a malicious actor may attempt to make a double spending and receive penalty after being detected, according to some embodiments of the present invention.

In this example, the Network is able to detect Alice, the creator of the micropayment pool, has double spent, and can ensure that the net value Alice gains from double spending is strictly negative. To detect double spending, validators nodes may check every on-chain transaction. If a remaining deposit in the micropayment pool cannot cover the next consolidated payment transaction signed by both Alice and another peer, the validators may consider that Alice has conducted a double spend, and ensure that Alice is worse off when she double spends.

In a more specific example, peers Bob, Carol, and David maybe honest while Alice is malicious. Even worse, she may collude with another malicious peer Edward. Alice exchanges partially signed transactions with Bob, Carol, and David for the specified resource. Since Alice gains no extra value for the duplicated resource, the maximum value she gets from Bob, Carol, and David is at most the deposit amount. As Alice colludes with Edward, she can send Edward the full deposit amount. She then asks Edward to commit the settlement transaction before anyone else and return her the deposit later. In other words, Alice gets the resource which is worth at most the deposit amount for free, before the double spending is detected. Later when Bob, Carol, or David commits the settlement transaction, the double spending is detected, and the full collateral amount will be slashed. Hence, the net return for Alice is netAlice=deposit−collateral. Therefore, for this scenario, as long as collateral>deposit, Alice's net return is negative. Hence, if Alice is rational, she would not have any incentive to double spend. Similarly, analysis for other cases show that Alice's net return is always negative if she conducts a double spend.

In another example, Alice is honest, but some of her peers are malicious. After Alice sends a micropayment to one of those peers, it might not return Alice the resource she wants. In this case, Alice can turn to another peer to get the resource. Since each incremental micropayment can be infinitesimally small in theory, Alice's loss can be made arbitrarily small.

### Many-to-One Micropayment Processing for Video Platform Engagement in P2P Streaming

In addition to facilitating P2P streaming between a viewer and multiple caching nodes, the THETA ledger system implemented according to the present invention has further utility and functionality on video platforms. For example, end-user viewers may gift content providers and popular influencers directly, or purchase virtual items and goods which can then be gifted to influencers. Advertisers and brand sponsors may also fund their advertising campaigns to automatically reward influencers whose video streams these advertisements will be displayed in, and optionally, advertisers may reward viewers for their attention to the stream content and advertisements. End-users may also purchase premium content, virtual goods and other paid products and services.

Moreover, video platform may encourage its users to share bandwidth by paying users based on the bandwidth shared. In an illustrative example, Alice may share data with peers Bob, Carol, and David, etc., and the video platform may reward Alice cryptocurrency tokens through a micropayment pool, with the processing protocol described below, according to one embodiment of the present invention. In this illustrative embodiment, a payment service module may verify signed service receipts and tracker authorizations, and send updated off-chain transactions to relay/cache nodes for eventual on-chain settlements.

FIG. 9 is a diagram 900 illustrating transactions through a resource-orientated micropayment pool established by a content distributor or video platform 901, showing an edge cacher 802 Alice (“peer A”) receiving off-chain payments for delivering data content to multiple viewers, including 804 Bob and 806 Carol, according to some embodiments of the present invention. In this particular example, the following steps are performed.

Step 1. Establishing a Peer Group for Data Sharing:

A tracker and payment server 903 peers viewers 802, 804, and 806 together into a group and gives one or more payment authorization certificates 910 to each participating peer. For example, an authorization certificate auth(Alice, Bob) may be given to Alice, which ensures that peers or viewers can only exchange payments within the viewer group that the tracker server establishes. As discussed previously with reference to FIG. 4B, a payment server or payment service module may be co-located with a tracker server or tracker service module. A payment server may also be run directly by video platform 901.

Step 2. Micropayment Pool Creation:

video platform 901 may create a micropayment pool with a time-lock and a slashable collateral with the payment service module, using the following exemplary command 920:
CreatePool(resourceId, deposit, collateral, duration).

Again, to create the pool, video platform 901 specifies a “Resource ID” resourceId that uniquely represents the digital content to be retrieved. It may refer to a video file, or a live stream. The deposit amount needs to be at least the total value of the resource to be retrieved. For instance, if the resource is a video file which is worth 10 tokens, then the deposit would be at least 10 tokens. The collateral is required to discourage double spending. If a double spending attempt is detected by validators of the blockchain network, the collateral may be slashed. The duration is a time-lock similar to that of a standard payment channel. Any withdrawal from the payment pool has to be before the time-lock expires. In the case of a live stream, a deleted deposit may be automatically re-filled to avoid any double spend confusion.

With the goal of video platform 901 rewarding its viewers for bandwidth sharing, payment server or payment service module 903 here may be maintained by a third party, to provide token custody service for video platform 901. Video platform 901 may purchase cryptocurrencies from the market, and store purchased tokens in the payment server. When video platform 901 needs to submit the funding transaction, it may call an API provided by payment server 903 to initiate the process. In some other embodiments, video platform 901 may run payment server 903 directly, and the funding transaction submission may be implemented as an internal call.

After the funding transaction has been committed, payment server 903 returns information 922 to video platform 901, including the Merkle proof of the CreatePool( ) transaction after it has been committed, as well as createPoolTxHash, the transaction hash of the CreatePool( ) transaction. Video platform 901 passes the Merkle proof to Alice in a notification message 924 so Alice is aware of the creation of the micropayment pool. In some embodiments, the notification message may contain other data types and/or structures instead.

Step 3. Data Sharing:

Alice shares data 930 with peer Bob, and data 932 with peer Carol, concurrently or asynchronously. Data 930 and 932 may each be a portion of the digital content data resource previously specified. For example, they may each be a fragment or slice of a video file, a single data packet, a live stream segment, and the like.

Step 4. Off-Chain Micropayments:

Bob signs a ServiceReceipt 940 and sends it to Alice off-chain in exchange for the parts of the specified resource. Similarly, Carol signs a ServiceReceipt 942 and sends it back to Alice off-chain.

Step 5. Micropayment Receipt Submission:

When Alice receives a micropayment receipt from peers it has served, Alice submits the micropayment receipt to payment server 903 along with the authorization certificate, as upload data 950. Payment server 903 needs to verify 1) the ServiceReceipts signed by each peer, and 2) the tracker server has authorized sharing between each peer and Alice.

Step 6. On-Chain Settlement:

payment server 903 sends Alice an updated off-chain transaction 960 which accumulates the total payment Alice has received so far, so Alice can submit it as an on-chain transaction 970 to the blockchain anytime and claim the updated balance of the reward 972. Transaction 960 may contain the following data:

targetAddress, transferAmount, createPoolTxHash, targetSettlementSequence, Sign(SK_{A}, targetAddress ∥ transferAmount ∥ createPoolTxHash targetSettlementSequence).

For the on-chain settlement, either the video platform or Alice can periodically publish the signed transactions to the blockchain any time before the timelock expires to reward Alice with the tokens. ServicePayment transactions that are published may be called “on-chain settlement” transactions.

Again, gas fee needs to be paid for the on-chain settlement transaction. Paying less transaction fees is a strong incentive to publish on-chain settlements only when necessary, which is beneficial to the scalability of the network.

Also, no on-chain transaction is needed when Alice shares a video stream with multiple peers simultaneously. In the video streaming context, this means the viewer can switch to any caching node at any time without making an on-chain transaction that could potentially block or delay the video stream delivery.

Additionally, in some embodiments, payment flow can run without trust for double spending. A peer may only provide the data-sharing service when he sees the micropayment pool is created in the blockchain. Subsequently, for each data packet, the peer may check if the video platform/payment server signs the corresponding micropayment transaction. If the peer detects a failure to sign a micropayment, it can stop bandwidth sharing. Thus, the peer may risk a single micropayment. Since each incremental micropayment may be infinitesimally small in theory, this loss may be made arbitrarily small. Alternatively, the peer may only send a data packet after receiving a signed payment for that packet, with the risk of loss borne by the video platform instead.

The use of a resource-orientated micropayment pool has shown significant performance gains in handling high-throughput micropayments. In one particular implementation of a livestream platform employing such a micropayment pool, on a daily basis, more than 100,000 aggregated on-chain payment transactions may be handled, whereas each on-chain transaction corresponds to about 30 to 40 off-chain micropayments on average. Thus, 3 to 4 million micropayments may be processed, yet this is still far below the achievable throughput limit the system is designed for.

### Applications of Micropayment Pool Beyond Video Streaming

In the above discussion, the resource-oriented micropayment pool is presented in the video delivery context. It can be used in other applications as well, as long as a resource can be identified where a user can gain no extra value when he or she obtains multiple copies of the resource from different peers. Here are a few examples: a resource can be a generic file, so the resource oriented micropayment pool can facilitate generic file sharing/storage. In the context of app distribution (e.g. APPLE APPSTORE, GOOGLEPLAY, etc.), an app can be considered as a resource. A resource can also be a certain type of service, e.g., a file compression service, a video transcoding service, solving a set of linear equations, etc. For these services, the requester gains no extra value by getting the same service from two vendors.

### CONCLUSIONS

One of ordinary skill in the art knows that the use cases, structures, schematics, and flow diagrams may be performed in other orders or combinations, but the inventive concept of the present invention remains without departing from the broader scope of the invention. Every embodiment may be unique, and methods/steps may be either shortened or lengthened, overlapped with the other activities, postponed, delayed, and continued after a time gap, such that every end-user device is accommodated by the server to practice the methods of the present invention.

The present invention may be implemented in hardware and/or in software. Many components of the system, for example, signal processing modules or network interfaces etc., have not been shown, so as not to obscure the present invention. However, one of ordinary skill in the art would appreciate that the system necessarily includes these components. A computing device, as illustrated in FIG. 6, is a hardware that includes at least one processor coupled to a memory. The processor may represent one or more processors (e.g., microprocessors), and the memory may represent random access memory (RAM) devices comprising a main storage of the hardware, as well as any supplemental levels of memory, e.g., cache memories, non-volatile or back-up memories (e.g., programmable or flash memories), read-only memories, etc. In addition, the memory may be considered to include memory storage physically located elsewhere in the hardware, e.g. any cache memory in the processor, as well as any storage capacity used as a virtual memory, e.g., as stored on a mass storage device.

The hardware of a computing device also typically receives a number of inputs and outputs for communicating information externally. For interface with a user, the hardware may include one or more user input devices (e.g., a keyboard, a mouse, a scanner, a microphone, a camera, etc.) and a display (e.g., a Liquid Crystal Display (LCD) panel). For additional storage, the hardware my also include one or more mass storage devices, e.g., a floppy or other removable disk drive, a hard disk drive, a Direct Access Storage Device (DASD), an optical drive (e.g., a Compact Disk (CD) drive, a Digital Versatile Disk (DVD) drive, etc.) and/or a tape drive, among others. Furthermore, the hardware may include an interface to one or more networks (e.g., a local area network (LAN), a wide area network (WAN), a wireless network, and/or the Internet among others) to permit the communication of streaming content and information with other computers coupled to the networks. It should be appreciated that the hardware typically includes suitable analog and/or digital interfaces to communicate with each other.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

The hardware operates under the control of an operating system, and executes various computer software applications, components, program code, libraries, objects, modules, etc. to perform the methods, processes, and techniques described above.

In general, the method executed to implement the embodiments of the invention may be implemented as part of an operating system or a specific application, component, program, object, module or sequence of instructions referred to as “computer program(s)” or “program code(s).” The computer programs typically comprise one or more instructions set at various times in various memory and storage devices in a computing device or computer, and that, when read and executed by one or more processors in the computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMS), Digital Versatile Disks, (DVDs), etc.), and digital and analog communication media.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally related may be stored together such as, for example, in a particular directory, folder, or library. Software components may be static (for example, pre-established or fixed) or dynamic (for example, created or modified at the time of execution).

Software components may invoke or be invoked by other software components through any of a wide variety of mechanisms. Invoked or invoking software components may comprise other custom-developed application software, operating system functionality (for example, device drivers, data storage (for example, file management) routines, other common routines and services, etc.), or third-party software components (for example, middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Although the present invention has been described with reference to specific exemplary embodiments, it will be evident that the various modification and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention.

1. A computer-implemented method utilized by a cacher for receiving a blockchain-based payment from a payment service module, in exchange for sharing a data resource with at least two viewers, the method executable by a processor, the method comprising:
receiving a notification, upon creation of a micropayment pool on a blockchain by the payment service module, wherein the micropayment pool is created by submitting, to the blockchain, a funding transaction comprising a deposit for sharing the data resource t with the at least two viewers;
sharing a first portion of the data resource with a first viewer;
receiving a first service receipt signed by the first viewer for the first portion of the data resource;
submitting the first service receipt to the payment service module;
receiving a first off-chain transaction from the payment service module, wherein the first off-chain transaction comprises a first transfer of a first payment amount from the micropayment pool to the cacher, for the first portion of the data resource;
sharing a second portion of the data resource with a second viewer;
receiving a second service receipt signed by the second viewer for the second portion of the data resource;
submitting the second service receipt to the payment service module;
receiving a second off-chain transaction; from the payment service module, as an update to the first off-chain transaction, wherein the second off-chain transaction comprises a second transfer of a second payment amount from the micropayment pool to the cacher, for the first portion of the data resource and the second portion of the data resource; and
submitting the second off-chain transaction to the blockchain to claim the second payment amount from the micropayment pool.

2. The computer-implemented method of claim 1, further comprising:
joining a peer group for sharing the data resource with the at least two viewers; and
receiving a payment authorization certificate authorizing the sharing of the data resource with the first viewer and the second viewer.

3. The computer-implemented method of claim 2, further comprising:
submitting the payment authorization certificate to the payment service module.

4. The computer-implemented method of claim 1, wherein the blockchain utilizes a validator committee of mining nodes to mine new blocks in a block settlement process.

5. The computer-implemented method of claim 4, wherein the blockchain further utilizes guardian nodes to validate the blockchain at checkpoint blocks, in a block finalization process, and wherein the checkpoint blocks are a subset of blocks in the blockchain.

6. The computer-implemented method of claim 1,
wherein the notification comprises a Merkle Proof of the funding transaction after the funding transaction has been included in a new block.

7. The computer-implemented method of claim 1, wherein the micropayment pool is associated with a resource ID for the data resource, a time-lock, and a slashable collateral.

8. A cacher system for receiving a blockchain-based payment from a payment service module, in exchange for sharing a data resource with at least two viewers, comprising:
at least one processor;
a non-transitory physical medium for storing program code accessible by the at least one processor, wherein the program code when executed by the processor causes the processor to:
receive a notification, upon creation of a micropayment pool on a blockchain by the payment service module, wherein the micropayment pool is created by submitting, to the blockchain, a funding transaction comprising a deposit for sharing the data resource to with the at least two viewers;
share a first portion of the data resource with a first viewer;
receive a first service receipt signed by the first viewer for the first portion of the data resource;
submit the first service receipt to the payment service module;
receive a first off-chain transaction from the payment service module, wherein the first off-chain transaction comprises a first transfer of a first payment amount from the micropayment pool to the cacher, for the first portion of the data resource;
share a second portion of the data resource with a second viewer;
receive a second service receipt signed by the second viewer for the second portion of the data resource;
submit the second service receipts to the payment service module;
receive a second off-chain transaction; from the payment service module, as an update to the first off-chain transaction, wherein the second off-chain transaction comprises a second transfer of a second payment amount from the micropayment pool to the cacher, for the first portion of the data resource and the second portion of the data resource; and
submit the second off-chain transaction to the blockchain to claim the second payment amount from the micropayment pool.

9. The cacher system of claim 8, wherein the program code when executed by the processor further causes the processor to:
join a peer group for sharing the data resource with the at least two viewers; and
receive a payment authorization certificate authorizing the sharing of the data resource with the first viewer and the second viewer.

10. The cacher system of claim 9, wherein the program code when executed by the processor further causes the processor to:
submit the payment authorization certificate to the payment service module.

11. The cacher system of claim 8, wherein the blockchain utilizes a validator committee of mining nodes to mine new blocks in a block settlement process.

12. The cacher system of claim 11, wherein the blockchain further utilizes guardian nodes to validate the blockchain at checkpoint blocks, in a block finalization process, and wherein the checkpoint blocks are a subset of blocks in the blockchain.

13. The cacher system of claim 8,
wherein the notification comprises a Merkle Proof of the funding transaction after the funding transaction has been included in a new block.

14. The cacher system of claim 8, wherein the micropayment pool is associated with a resource ID for the data resource, a time-lock, and a slashable collateral.

15. A non-transitory storage medium for storing program code, utilized by a cacher, for receiving a blockchain-based payment from a payment service module, in exchange for sharing a data resource to with at least two viewers, wherein the program code is executable by a processor, and wherein the program code when executed by the processor causes the processor to:
receive a notification, upon creation of a micropayment pool on a blockchain by a payment service module, wherein the micropayment pool is created b submitting, to the blockchain, a funding transaction comprising a deposit for sharing the data resource with the at least two viewers;
share a first portion of the data resource with a first viewer;
receive a first service receipt signed by the first viewer for the first portion of the data resource;
submit the first service receipt to the payment service module;
receive a first off-chain transaction from the payment service module, wherein the first off-chain transaction comprises a first transfer of a first payment amount form the micropayment pool to the cacher, for the first portion of the data resource;
share a second portion of the data resource with a second viewer;
receive a second service receipt signed by the second viewer for the second portion of the data resource;
submit the second service receipts to the payment service module;
receive a second off-chain transaction, from the payment service module, as an update to the first off-chain transaction, wherein the second off-chain transaction comprises a second transfer of a second payment amount from the micropayment pool to the cacher, for the first portion of the data resource and the second portion of the data resource; and
submit the second off-chain transaction to the blockchain to claim the second payment amount from the micropayment pool.

16. The non-transitory storage medium of claim 15, wherein the program code when executed by the processor further causes the processor to:
join a peer group for sharing the data resource with the at least two viewers; and
receive a payment authorization certificate authorizing the sharing of the data resource with the first viewer and the second viewer.

17. The non-transitory storage medium of claim 16, wherein the program code when executed by the processor further causes the processor to:
submit the payment authorization certificate to the payment service module.

18. The non-transitory storage medium of claim 15, wherein the blockchain utilizes a validator committee of mining nodes to mine new blocks in a block settlement process.

19. The non-transitory storage medium of claim 18, wherein the blockchain further utilizes guardian nodes to validate the blockchain at checkpoint blocks, in a block finalization process, and wherein the checkpoint blocks are a subset of blocks in the blockchain.

20. The non-transitory storage medium of claim 15,
wherein the notification comprises a Merkle Proof of the funding transaction after the funding transaction has been included in a new block.
